(19) United States
(12) Patent Application Publication
(10) Pub. No.: US 2024/0055732 A1
(43) Pub. Date: Feb. 15, 2024

(54) Battery Compartment, Battery Pack and Electric Device

(71) Applicant: JIANGSU ZENERGY BATTERY TECHNOLOGIES CO., LTD., Jiangsu (CN)

(72) Inventors: Zhiying WU, Jiangsu (CN); Qingtao XU, Jiangsu (CN); Qingchao WANG, Jiangsu (CN); Fei SUN, Jiangsu (CN)

(21) Appl. No.: 18/137,997

(22) Filed: Apr. 21, 2023

(30) Foreign Application Priority Data
Aug. 11, 2022 (CN) 202210958347.1

(51) Int. Cl. H01M 50/503; H01M 50/209; H01M 50/291; H01M 50/509

(52) U.S. Cl. CPC H01M 50/503; H01M 50/209; H01M 50/291; H01M 50/509

(57) ABSTRACT

The disclosure relates to the technical field of batteries. Disclosed are a battery compartment, a battery pack and an electric device. The battery compartment includes a battery shell and a battery cell assembly; the battery shell is provided with a male port opening and a female port opening; the battery cell assembly is disposed in the battery shell, and includes a connection bar and a plurality of battery cells; the connection bar is configured to electrically connect the plurality of battery cells, and is provided with a male port pole and a female port pole; and the male port pole protrudes from the male port opening, and the female port pole protrudes from the female port opening.

### CROSS-REFERENCE TO RELATED APPLICATION

This application claims priority to Patent Application No. 202210958347.1, filed to China National Intellectual Property Administration on Aug. 11, 2022 and entitled “Battery Compartment, Battery Pack and Electric Device”, the disclosure of which is hereby incorporated by reference in its entirety.

### TECHNICAL FIELD

The disclosure relates to the technical field of batteries, and specifically, to a battery compartment, a battery pack and an electric device.

### BACKGROUND

Generally speaking, a battery pack is of an entire structure, in which all battery cells are assembled in a box body, so as to form a closed battery system. The assembly and maintenance of the battery cells need to be achieved by assembling the whole pack, resulting in extremely inconvenient disassembling and assembling of the battery, long maintenance time and high maintenance cost.

For this purpose, in the prior art, a plurality of battery cells are integrated into a module, and then a plurality of modules are assembled to form a battery pack, such that when any battery cell is damaged, the corresponding module can be assembled and disassembled. However, the module is complex in structure, and the assembly and disassembly of the module still have the problems of long maintenance time and high maintenance cost.

### SUMMARY

Some embodiments of the disclosure are intended to provide a battery compartment with a simple structure and convenient assembling and disassembling, so as to improve maintenance efficiency and reduce maintenance cost. In addition, the battery compartment is connected to an electrical structure or other battery compartments by means of a male port pole and a female port pole, such that a connection bar does not need to be externally disposed, and the size of the connection bar is decreased, and therefore, production costs can be reduced.

An embodiment of the disclosure is intended to further provide a battery pack. The battery pack includes the battery compartment. Therefore, the battery pack also has the advantages of being simple in structure, convenient in assembling and disassembling, high in maintenance efficiency and low in production cost.

An embodiment of the disclosure is intended to further provide an electric device. The electric device is powered by means of the battery compartment or the battery pack. Therefore, the electric device also has the advantage of being low in cost.

Embodiments of the disclosure are able to be implemented as follows.

In an embodiment, the disclosure provides a battery compartment. The battery compartment includes a battery shell and a battery cell assembly.

The battery shell is provided with a male port opening and a female port opening.

The battery cell assembly is disposed in the battery shell, and includes a connection bar and a plurality of battery cells. The connection bar is configured to electrically connect the plurality of battery cells and is provided with a male port pole and a female port pole. The male port pole protrudes from the male port opening, and the female port pole protrudes from the female port opening.

In an implementation, the battery shell is provided with two male port openings and two female port openings. The two male port openings are respectively provided on a first side and a second side of the battery shell that are opposite to each other, and the two female port openings are respectively provided on the first side and the second side.

The connection bar is provided with two male port poles and two female port poles. The two male port poles respectively protrude from the two male port openings, and the two female port poles respectively protrude from the two female port openings.

In an implementation, the male port pole and the female port pole, which protrude from the first side, are both provided with pole grooves, and external sizes of the female port pole and the male port pole, which protrude from the second side, match internal sizes of the pole grooves;
or,
one of the two male port poles protruding from the first side and the second side is provided with the pole groove; and one of the two female port poles protruding from the first side and the second side is provided with the pole groove. One of the male port pole and the female port pole that is provided with the pole groove is located on the first side, and the other is located on the second side. The external sizes of the male port pole and the female port pole which are not provided with the pole grooves match the internal sizes of the pole grooves.

In an implementation, the plurality of battery cells are arranged in series or parallel by means of the connection bar.

In an implementation, a positive pole and a negative pole of each battery cell of the plurality of battery cells are respectively disposed on two end surfaces of the each battery cell. The plurality of battery cells are arranged in a stacking manner. In a stacking direction, the positive pole of one battery cell of the plurality of battery cells is arranged close to the negative pole of the other battery cell of the plurality of battery cells. After the plurality of battery cells are arranged in a stacking manner, first-row pole and second-row pole are respectively formed at positions facing a third side and a fourth side of the battery shell. The first-row pole and the second-row pole include a plurality of positive poles and a plurality of negative poles which are successively alternately arranged in the stacking direction.

The connection bar includes a positive connection bar and a negative connection bar. The positive connection bar includes a positive main body and a plurality of first bar plates. One of the plurality of first bar plates is connected to the positive main body, and is connected to one positive pole in the first-row pole that is located at an end portion. The rest of the first bar plates of the plurality of first bar plates are successively electrically connected to the rest of the plurality of positive poles and the plurality of negative poles in the first-row pole. The negative connection bar includes a negative main body and a plurality of second bar plates. One of the plurality of second bar plates is connected to the negative main body and is connected to one negative pole in the second-row pole that is located at an end portion. The rest of the second bar plates of the plurality of second bar plates are successively electrically connected to the rest of the plurality of positive poles and the plurality of negative poles in the second-row pole, so as to make the plurality of battery cells successively arranged in series.

The two male port poles are respectively disposed on two ends of the positive main body that are close to the first side and the second side, so as to respectively protrude from the male port openings of the first side and the second side. The two female port poles are respectively disposed on two ends of the negative main body that are close to the first side and the second side, so as to respectively protrude from the female port openings of the first side and the second side.

In an implementation, a positive pole and a negative pole of each battery cell of the plurality of battery cells are disposed on the same end surface of the battery cell. The plurality of battery cells are arranged in a stacking manner, and after stacking, first-row pole and second-row pole, which are arranged side by side, are formed at positions facing the same side of the battery shell. The first-row pole and the second-row pole include a plurality of positive poles and a plurality of negative poles which are successively alternately arranged in a stacking direction.

The connection bar includes a positive connection bar and a negative connection bar. The positive connection bar includes a positive main body and a plurality of first bar plates. One of the plurality of first bar plates is connected to the positive main body, and is connected to one positive pole in the first-row pole that is located at an end portion. The rest of the first bar plates of the plurality of first bar plates are successively electrically connected to the rest of the plurality of positive poles and the plurality of negative poles in the first-row pole. The negative connection bar includes a negative main body and a plurality of second bar plates. One of the plurality of second bar plates is connected to the negative main body and is connected to one negative pole in the second-row pole that is located at an end portion. The rest of the second bar plates of the plurality of second bar plates are successively electrically connected to the rest of the plurality of positive poles and the plurality of negative poles in the second-row pole, so as to make the plurality of battery cells successively arranged in series.

The two male port poles are respectively disposed on two ends of the positive main body that are close to the first side and the second side, so as to respectively protrude from the male port openings of the first side and the second side. The two female port poles are respectively disposed on two ends of the negative main body that are close to the first side and the second side, so as to respectively protrude from the female port openings of the first side and the second side.

In an implementation, the battery shell is provided with embedded grooves in the sides of the male port opening and the female port opening that are close to the battery cells, and the embedded grooves are capable of communicating with the corresponding male port opening or the corresponding female port opening.

The battery compartment further includes a plurality of first insulating pads corresponding to the number of the embedded grooves. Each first insulating pad is provided with a hole which is coaxial with the corresponding male port opening or the female port opening, and at least part of each first insulating pad is capable of being accommodated in the embedded groove. The first insulating pad at the male port opening is disposed outside the corresponding male port pole in a sleeving manner, and abuts against a wall surface of the connection bar that is provided with the male port pole. The first insulating pad at the female port opening is disposed outside the corresponding female port pole in a sleeving manner, and abuts against a wall surface of the connection bar that is provided with the female port pole.

In an implementation, the battery compartment further includes a plurality of second insulating pads corresponding to the number of the embedded grooves. The first insulating pads are all accommodated in the corresponding embedded grooves. The second insulating pads are at least partially accommodated in the embedded groove. The first insulating pad and the second insulating pad at the male port opening are respectively abut against two sides of the wall surface of the connection bar that is provided with the male port pole. The first insulating pad and the second insulating pad at the female port opening are respectively abut against two sides of the wall surface of the connection bar that is provided with the female port pole.

In an implementation, the second insulating pads are provided with inserting grooves, and the inserting grooves are connected to the connection bar in an inserting manner.

In an implementation, the battery shell has a first side and a second side, which are opposite to each other. One of the first side and the second side is provided with an inserting hole, and the other one of the first side and the second side is provided with an inserting column. An external size of the inserting column matches an internal size of the inserting hole.

In an implementation, the battery shell has a first side and a second side, which are opposite to each other. At least one of the first side or the second side is provided with a sealing groove. The battery compartment further includes a sealing ring which is capable of being at least partially accommodated in the sealing groove.

In an embodiment, the disclosure provides a battery pack, which includes any one of the battery compartments in the foregoing implementations.

In an implementation, the battery pack further includes an electrical bin. The electrical bin is provided with a male port and a female port. The male port pole of the battery compartment is connected to the male port in an inserting manner, and the female port pole is connected to the female port in an inserting manner.

In an implementation, the battery pack includes a plurality of battery compartments which are arranged in a stacking manner. Each battery compartment is provided with two male port poles and two female port poles. The two male port poles are respectively disposed on a first side and a second side of a battery shell that are opposite to each other, and the two female port poles are respectively disposed on the first side and the second side.

In a stacking direction of the plurality of battery compartments, in two adjacent battery compartments, the male port pole and the female port pole of the first side of one battery compartment are connected to the male port pole and the female port pole of the second side of the other battery compartment in an inserting manner, so as to achieve a parallel connection of the plurality of battery compartments; or in the stacking direction of the plurality of battery compartments, in the two adjacent battery compartments, the male port pole of the first side of one battery compartment is connected to the female port pole of the second side of the other battery compartment in an inserting manner, so as to achieve a series connection of the plurality of battery compartments.

In an implementation, the plurality of battery compartments are arranged in parallel. After the plurality of battery compartments are connected in parallel, the remaining male port pole and female port pole are located on the same sides of the battery compartments.

The battery pack further includes an electrical bin. The electrical bin is provided with a male port and a female port. The remaining male port pole is connected to the male port in an inserting manner, and the remaining female port pole is connected to the female port in an inserting manner.

In an implementation, the battery shell has a first side and a second side, which are opposite to each other. The first side is provided with an inserting column, the second side is provided with an inserting hole, and an external size of the inserting column matches an internal size of the inserting hole.

When the first side of the battery compartment matching the electrical bin is arranged close to the electrical bin, a bin wall of the electrical bin is provided with the inserting hole, and the inserting hole is connected to the inserting column at a corresponding position. When the second side of the battery compartment matching the electrical bin is arranged close to the electrical bin, the bin wall of the electrical bin is provided with the inserting column, and the inserting column is connected to the inserting hole at a corresponding position.

In an implementation, the battery pack further includes a frame. The battery pack includes a plurality of battery compartments which are arranged in the frame in a stacking manner, and in a stacking direction of the plurality of battery compartments, the battery compartment located at a far end portion is firmly connected to the frame;
or,
the battery pack further includes a frame and an electrical bin. The battery pack includes a plurality of battery compartments, the electrical bin and the plurality of battery compartments are successively arranged in the frame in a stacking manner, the electrical bin is firmly connected to the frame, and the battery compartment in the plurality of battery compartments that is away from the electrical bin is firmly connected to the frame.

In an implementation, the battery pack further includes a frame. The frame is provided with a sliding groove, and the battery compartment is connected to the sliding groove in an inserting manner.

In an implementation, the frame includes a first side beam and a second side beam which are opposite to and spaced apart from each other, and a first baffle plate and a second baffle plate which are opposite to each other and arranged between the first side beam and the second side beam in a spaced manner. The first side beam, the second side beam, the first baffle plate and the second baffle plate jointly form a square frame body.

The first side beam and the second side beam are respectively provided with the sliding grooves. Two ends of the battery compartment are respectively connected to the two sliding grooves in an inserting manner, and slide in an extending direction of the sliding grooves.

In an implementation, at least one groove wall of the sliding groove is provided with a roller, and the battery compartment is in sliding fit with the roller.

In an implementation, the battery pack includes a plurality of battery compartments, and further includes a frame. The plurality of battery compartments are arranged in the frame in a stacking manner. In a stacking direction of the plurality of battery compartments, an insulation sealing gasket is disposed between the battery compartment located at a far end portion and a corresponding position of the frame.

In an embodiment, the disclosure provides an electric device. The electric device includes
an electric mechanism, and any one of the battery compartments in the foregoing implementations, or any one of the battery packs in the foregoing implementations.

The battery compartment is configured to supply power for the electric mechanism; and the battery pack is configured to supply power for the electric mechanism.

The embodiments of the disclosure at least have the following advantages or beneficial effects.

An embodiment of the disclosure provides a battery compartment. The battery compartment includes a battery shell and a battery cell assembly; the battery shell is provided with a male port opening and a female port opening; the battery cell assembly is disposed in the battery shell, and includes a connection bar and a plurality of battery cells; the connection bar is configured to electrically connect the plurality of battery cells, and is provided with a male port pole and a female port pole; and the male port pole protrudes from the male port opening, and the female port pole protrudes from the female port opening. On the one hand, the battery cell assembly of the battery compartment directly protrudes from an opening by means of the male port pole and the female port pole, such that an electrical connection with other battery compartments or electrical structures can be realized, thereby achieving charging and discharging; and the battery compartment is simple in structure, and the connection bar does not need to be externally disposed, such that the size of the connection bar can be decreased, and production costs can be reduced. On the other hand, the battery compartment is of a modular structure, and is assembled and disassembled by mating with and separating the male port pole and the female port pole from structures which are respectively adjacent to the male port pole and the female port pole, such that maintenance efficiency can be improved, and maintenance costs can be reduced.

An embodiment of the disclosure further provides a battery pack. The battery pack includes the battery compartment. Therefore, the battery pack also has the advantages of being simple in structure, convenient in assembling and disassembling, high in maintenance efficiency and low in production cost.

An embodiment of the disclosure further provides an electric device. The electric device is powered by means of the battery compartment or the battery pack. Therefore, the electric device also has the advantage of being low in cost.

### BRIEF DESCRIPTION OF THE DRAWINGS

In order to illustrate the technical solutions in the embodiments of the disclosure more clearly, the drawings used in the embodiments will be briefly introduced below. It is to be understood that the following drawings only illustrate some embodiments of the present disclosure, which therefore should not be regarded as limitations to the scope. For those of ordinary skill in the art, other related drawings may also be obtained in accordance with these drawings without creative efforts.

FIG. 1 is a schematic structural diagram of a battery pack according to an embodiment of the disclosure.

FIG. 2 is a schematic exploded view of a battery pack according to an embodiment of the disclosure.

FIG. 3 is a schematic structural diagram of a frame of a battery pack according to an embodiment of the disclosure.

FIG. 4 is a schematic structural diagram I of a battery compartment according to an embodiment of the disclosure.

FIG. 5 is a partial enlarged view of a part I in FIG. 4.

FIG. 6 is a schematic structural diagram II of a battery compartment according to an embodiment of the disclosure.

FIG. 7 is a partial enlarged view of a part II in FIG. 6.

FIG. 8 is a schematic exploded view of a battery compartment according to an embodiment of the disclosure.

FIG. 9 is a schematic diagram I of a partial structure of a battery compartment according to an embodiment of the disclosure.

FIG. 10 is a schematic diagram II of a partial structure of a battery compartment according to an embodiment of the disclosure.

FIG. 11 is a schematic cross-sectional view of a battery compartment according to an embodiment of the disclosure.

FIG. 12 is a schematic diagram III of a partial structure of a battery compartment according to an embodiment of the disclosure.

FIG. 13 is a schematic structural diagram I of another battery compartment according to an embodiment of the disclosure.

FIG. 14 is a partial enlarged view of a part III in FIG. 13.

FIG. 15 is a schematic structural diagram II of another battery compartment according to an embodiment of the disclosure.

FIG. 16 is a partial enlarged view of a part IV in FIG. 15.

FIG. 17 is a schematic exploded view of another battery compartment according to an embodiment of the disclosure.

FIG. 18 is a schematic diagram I of a partial structure of another battery compartment according to an embodiment of the disclosure.

FIG. 19 is a schematic cross-sectional view of another battery compartment according to an embodiment of the disclosure.

FIG. 20 is a schematic diagram II of a partial structure of another battery compartment according to an embodiment of the disclosure.

In the drawings: 100—Battery pack; 101—Electrical bin; 103—Frame; 104—First side beam; 105—Second side beam; 106—First baffle plate; 107—Second baffle plate; 108—Sliding groove; 109—Roller; 110—First mounting hole; 111—Second mounting hole; 112—Battery compartment; 113—Battery shell; 114—Male port opening; 115—Female port opening; 116—Male port pole; 117—Female port pole; 119—Upper cover plate; 120—Bearing plate; 121—Front plate; 122—Rear plate; 123—First side; 124—Second side; 125—Third side; 126—Fourth side; 127—Pole groove; 128—Positive connection bar; 129—Positive main body; 130—First bar plate; 131—Negative connection bar; 132—Main negative body; 133—Second bar plate; 134—Embedded groove; 135—First insulating pad; 136—Second insulating pad; 137—Inserting groove; 138—Inserting column; 139—Inserting hole; 140—Sealing groove; 141—Battery cell assembly; 142—Battery cell.

### DETAILED DESCRIPTION OF THE EMBODIMENTS

In order to make objectives, technical solutions, and advantages of embodiments of the disclosure clearer, the technical solutions in the embodiments of the disclosure will be clearly and completely described below in combination with the drawings in the embodiments of the disclosure. It is apparent that the described embodiments are part of the embodiments of the disclosure, not all the embodiments. Components of the embodiments of the disclosure generally described and illustrated here in the drawings is able to be arranged and designed in various different configurations.

Therefore, the following detailed descriptions of the embodiments of the disclosure provided in the drawings are not intended to limit the scope of the claimed invention, but only represent selected embodiments of the disclosure. Based on the embodiments in the disclosure, all other embodiments obtained by those of ordinary skill in the art without creative work shall fall within the protection scope of the disclosure.

It is to be noted that similar numbers and letters indicate similar items in the following drawings, so once a certain item is defined in one drawing, no further definitions and explanations are required for same in the subsequent drawings.

In descriptions of the disclosure, it is to be noted that, direction or position relationships indicated by terms such as “central”, “upper”, “lower”, “left”, “right”, “vertical”, “horizontal”, “inner”, and “outer” and the like are direction or position relationships based on the accompanying drawings, or the direction or position relationships in which the product of the disclosure is customarily placed when in use, and are merely intended to facilitate the descriptions of the disclosure and simplify the descriptions, rather than indicating or implying that a referred apparatus or element must have a particular direction or be constructed and operated in a particular direction. Therefore, these terms should not be interpreted as limiting the disclosure. In addition, the terms “first”, “second” and “third” are for distinguishing purposes only, and should not be construed as indicating or implying relative importance.

In addition, the terms “horizontal” and “vertical” do not mean that the part is required to be absolutely horizontal or overhanging, but may be slightly inclined. For example, “horizontal” only means that the direction thereof is more horizontal compared to “vertical”, it does not mean that the structure must be completely horizontal, but may be slightly inclined.

In the description of the disclosure, it is to be further noted that, unless otherwise clearly specified and limited, the terms “disposed”, “mounted”, “connected” and “connect” should be interpreted broadly. For example, the term “connect” may be fixed connection, detachable connection or integral construction. As an alternative, the term “connect” may be mechanical connection, or electrical connection. As an alternative, the term “connect” may be direct connection, or indirect connection through a medium, or communication in two elements. For those of ordinary skill in the art, specific meanings of the above terms in the disclosure may be understood according to a specific condition.

In the related art, a battery pack is of an entire structure, in which all battery cells are assembled in a box body, so as to form a closed battery system. The assembly and maintenance of the battery cells need to be achieved by assembling the whole pack, resulting in extremely inconvenient disassembling and assembling of the battery, long maintenance time and high maintenance cost. For this purpose, in the prior art, a plurality of battery cells are integrated into a module, and then a plurality of modules are assembled to form a battery pack, such that when any battery cell is damaged, the corresponding module can be assembled and disassembled. However, the module is complex in structure, and the assembly and disassembly of the module still have the problems of long maintenance time and high maintenance cost.

In view of this, this embodiment provides a battery compartment with a simple structure and convenient assembling and disassembling, so as to improve maintenance efficiency and reduce maintenance cost. In addition, the battery compartment is connected to an electrical structure or other battery compartments by means of a male port pole and a female port pole, such that a connection bar does not need to be externally disposed, and the size of the connection bar is decreased, and therefore, production costs can be reduced. The structure of the battery pack including the battery compartment is introduced in detail below.

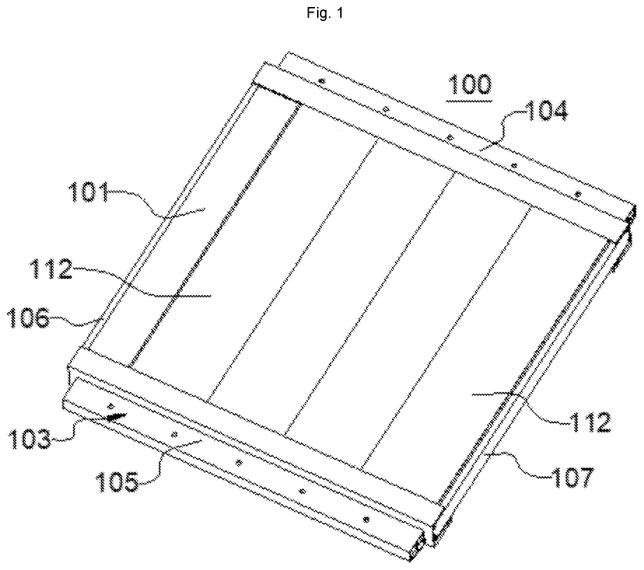

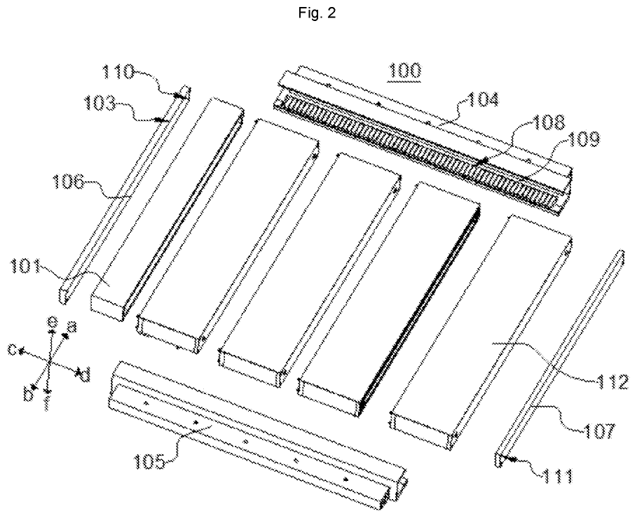

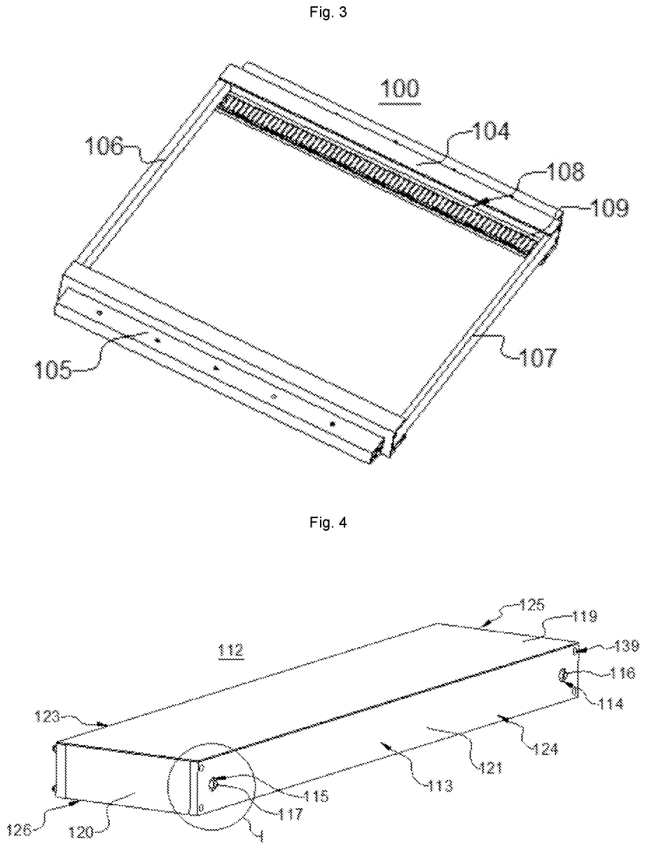

FIG. 1 is a schematic structural diagram of a battery pack 100 according to this embodiment. FIG. 2 is a schematic exploded view of a battery pack 100 according to this embodiment. FIG. 3 is a schematic structural diagram of a frame 103 of a battery pack 100 according to this embodiment. Referring to FIG. 1 to FIG. 3, the battery pack 100 provided in this embodiment includes a frame 103, a battery compartment 112 and an electrical bin 101. There is at least one battery compartment 112; and there is one electrical bin 101. The battery compartment 112 and the electrical bin 101 are modularly and independently arranged, and can both be in detachable fit with the frame 103. The battery compartment 112 and electrical bin 101 are modularly and independently arranged to facilitate assembly and disassembly, as well as maintenance, so as to ensure the efficiency and quality of maintenance operations. Definitely, the battery pack 100 may further include some function bins such as a cooling bin. The function bins are also arranged relatively independently to facilitate assembly and disassembly, so as to ensure the efficiency and quality of assembly and disassembly of the entire battery pack 100 and save the cost of assembly and disassembly and maintenance.

In detail, in this embodiment, the frame 103 is of a hollow structure; the frame 103 is provided with a sliding groove 108; and the electrical bin 101 and the battery compartment 112 are both in sliding fit with the sliding groove 108 of the frame 103, so as to facilitate assembly and disassembly. Specifically, the frame 103 includes a first side beam 104 and a second side beam 105 which are opposite to and spaced apart from each other in a first direction (that is, an ab direction in FIG. 2), and a first baffle plate 106 and a second baffle plate 107 which are opposite to each other and arranged between the first side beam 104 and the second side beam 105 in a spaced manner in a second direction perpendicular to the first direction (that is, a cd direction in FIG. 2, in other embodiments, the second direction may also be another direction at an included angle to the first direction). The first side beam 104, the second side beam 105, the first baffle plate 106 and the second baffle plate 107 jointly form a hollow square frame body. The first side beam 104 and the second side beam 105 are respectively provided with the sliding grooves 108. Two ends of the battery compartment 112 can be respectively connected to the two sliding grooves 108 in an inserting manner, and can slide in an extending direction of the sliding grooves 108; and two ends of the electrical bin 101 can also be respectively connected to the two sliding grooves 108 in an inserting manner, and can slide in an extending direction of the sliding grooves 108.

By means of such an arrangement, during the assembly of the battery pack 100, when there are a plurality of battery compartments 112, the first side beam 104, the second side beam 105 and the first baffle plate 106 are able to be firstly assembled; then the electrical bin 101 is slid by means of the sliding groove 108 and abuts against the first baffle plate 106; next, the plurality of battery compartments 112 successively slide into the sliding grooves 108, the plurality of battery compartments 112 and the electrical bin 101 are successively arranged in a stacking manner in the second direction, so as to make the battery compartment 112, which is closest to the electrical bin 101, in the plurality of battery compartments 112 on the far-end edge electrically connected to the electrical bin 101, and the plurality of battery compartments 112 can be electrically connected, such that the battery pack 100 can be charged and discharged; and finally, the second baffle plate 107 is assembled with the first side beam 104 and the second side beam 105.

In an aspect, by means of independently and modularly arranging the electrical bin 101 and the battery compartment 112, a single module may only need to be replaced during maintenance and replacement, such that maintenance cost and time can be effectively reduced; and the modular arrangement also facilitates mass manufacturing and production, such that industrial mass production demands can be met. In another aspect, by means of the cooperation of the sliding groove 108 and the frame 103, assembly and disassembly are conveniently achieved, such that production efficiency and quality can be improved. In addition, by means of designing the structure of the frame 103 to be of a hollow square frame body structure, a top plate and a bottom plate of the battery pack 100 are able to be saved, such that the structure of the battery pack 100 is lighter, energy density can be guaranteed, assembly and disassembly operations are performed, and the efficiency of assembly and disassembly and maintenance can be further improved. Furthermore, heat dissipation of the battery compartment 112 and the electrical bin 101 is achieved, such that the safety performance of the battery pack 100 can be guaranteed.

As an optional scheme, in order to conveniently slide the electrical bin 101 and the battery compartment 112, in this embodiment, at least one groove wall of the sliding groove 108 is provided with a roller 109, and the battery compartment 112 in sliding fit with the roller 109. Exemplarily, in this embodiment, the first side beam 104 and the second side beam 105 are both approximately of “C”-shaped structures. The “C”-shaped sliding grooves 108 are formed on an inner peripheral side of the “C”-shaped structures. A lower groove wall in the two groove walls of the sliding groove 108 in a vertical direction (that is, an ef direction in FIG. 2) is provided with a plurality of rollers 109, and the plurality of rollers 109 are successively arranged in the second direction. By means of the arrangement of the plurality of rollers 109, the electrical bin 101 and the battery compartment 112 are conveniently slide in and out, such that the efficiency and quality of assembly and disassembly can be further improved. Definitely, in other embodiments, an upper groove wall may also be correspondingly provided with a plurality of rollers 109 which are successively arranged in the second direction, and this embodiment is not limited thereto.

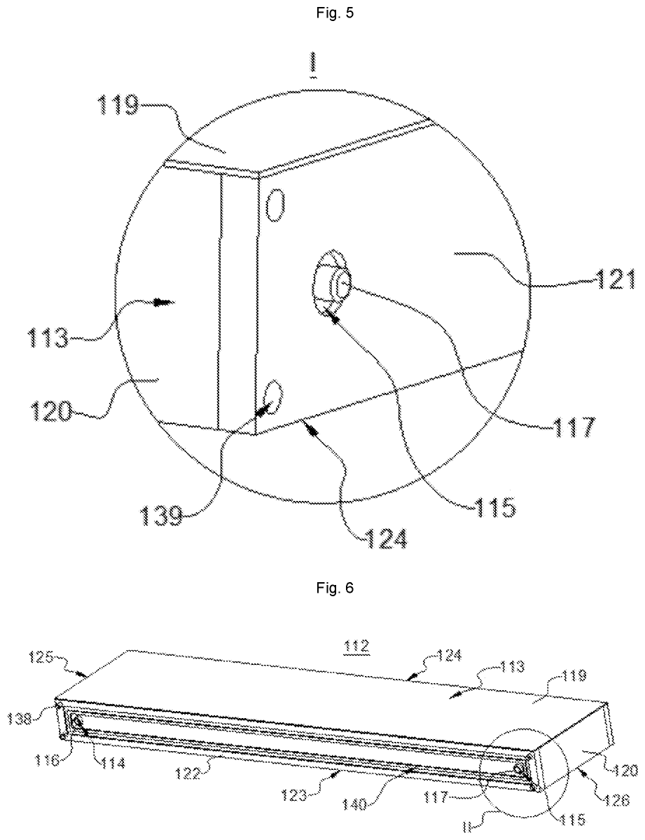

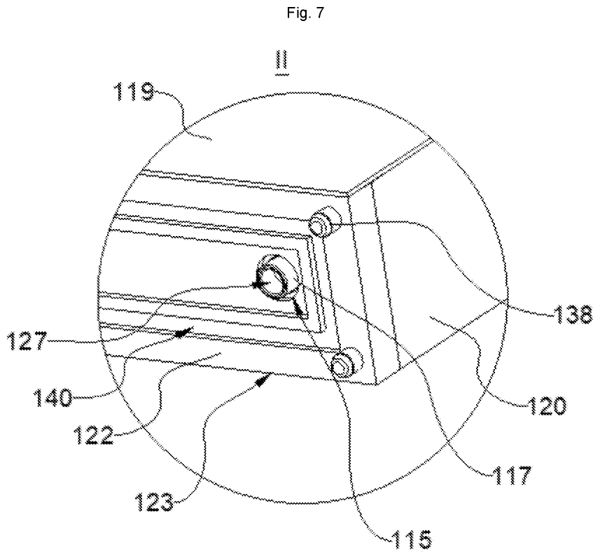

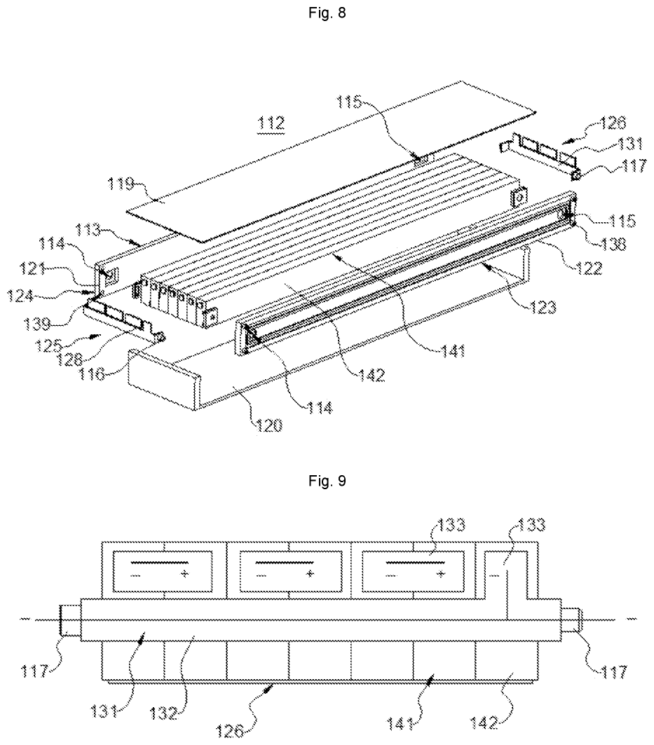

FIG. 4 is a schematic structural diagram I of a battery compartment 112 according to this embodiment. FIG. 5 is a partial enlarged view of a part I in FIG. 4. FIG. 6 is a schematic structural diagram II of a battery compartment 112 according to this embodiment. FIG. 7 is a partial enlarged view of a part II in FIG. 6. FIG. 8 is a schematic exploded view of a battery compartment 112 according to this embodiment. Referring to FIG. 4 to FIG. 8, in order to further improve the efficiency of assembly and disassembly of the battery compartment 112, in this embodiment, the battery compartment 112 specifically includes a battery shell 113 and battery cell assembly 141.

The battery shell 113 is provided with a male port opening 114 and a female port opening 115. Both the male port opening 114 and the female port opening 115 are circular through holes, of which shapes and sizes are able to be adjusted with the shapes and sizes of the poles. The battery cell assembly 141 is disposed in the battery shell 113. The battery cell assembly 141 includes a connection bar and a plurality of battery cells 142. The plurality of battery cells 142 are arranged in the second direction in a stacking manner, that is, being arranged in a stacking manner in the cd direction in FIG. 2. The connection bar is configured to electrically connect the plurality of battery cells 142, and an electrical connection mode is able to be a series connection or a parallel connection. The connection bar is provided with a male port pole 116 and a female port pole 117. The male port pole 116 protrudes from the male port opening 114, and the female port pole 117 protrudes from the female port opening 115.

Correspondingly, the electrical bin 101 is provided with a male port and a female port. When there is one battery compartment 112, the male port pole 116 of the battery compartment 112 that protrudes from the male port opening 114 is directly connected to the male port in an inserting manner, and the female port pole 117 of the battery compartment 112 that protrudes from the female port opening 115, such that the battery compartment 112 cooperates with the electrical bin 101, so as to be connected to an external electric device by means of the electrical bin 101. Likewise, when there are a plurality of battery compartments 112, the plurality of battery compartments 112 are first connected in series or parallel, and then cooperate with the male port and the female port. Since the electrical bin 101 and the battery compartments 112 are independently disposed, in order to achieve the convenience and reliability of the cooperation between the plurality of battery compartments 112 and the electrical bin 101 when there are a plurality of battery compartments 112, the plurality of battery compartments 112 are able to be arranged in parallel, so as to make the remaining male port pole 116 and female port pole 117 located on the same sides of the battery compartments 112, that is, located on the sides close to the electrical bin 101, after the plurality of battery compartments 112 are connected in parallel, such that the remaining male port pole 116 is connected to the male port in an inserting manner, and the remaining female port pole 117 is connected to the female port in an inserting manner.

By means of the above arrangement, on the one hand, the battery cell assembly 141 of the battery compartment 112 directly protrudes from an opening by means of the male port pole 116 and the female port pole 117, such that an electrical connection with other battery compartments 112 or electrical structures can be realized, thereby achieving charging and discharging; and the battery compartment is simple in structure, and the connection bar does not need to be externally disposed, such that the size of the connection bar can be decreased, and production costs can be reduced. On the other hand, the battery compartment 112 is of a modular structure, and is assembled and disassembled by mating with and separating the male port pole 116 and the female port pole 117 from structures which are respectively adjacent to the male port pole and the female port pole, such that maintenance efficiency can be improved, and maintenance costs can be reduced.

Further referring to FIG. 4 to FIG. 8, in this embodiment, the battery shell 113 includes a front plate 121 and a rear plate 122, which are disposed at intervals in the second direction, and a bearing plate 120 and an upper cover plate 119.

Specifically, the front plate 121 is a plate in the battery shell 113 that faces one side of the second baffle plate 107; and the rear plate 122 is a plate in the battery shell 113 that faces one side of the first baffle plate 106. The bearing plate 120 is connected between the front plate 121 and a bottom end of the rear plate 122 in a bended manner. Exemplarily, the bearing plate 120 is able to be designed as a “C”-shaped structure, and the “C”-shaped structure is able to be obtained by integrally forming or welding three plate-like structures which are successively perpendicularly connected. In other embodiments, the shape of the bearing plate 120 may further be adjusted according to needs, which is not described herein again. The upper cover plate 119 is connected between the front plate 121 and a top end of the rear plate 122. The front plate 121, the rear plate 122, the bearing plate 120 and the upper cover plate 119 jointly form a square shell structure, so as to guarantee the safety and stability of the battery cell assembly 141. In addition, the battery shell 113 is provided with two male port openings 114 and two female port openings 115. The two male port openings 114 are respectively provided on a first side 123 and a second side 124 of the battery shell 113 that are opposite to each other, and the two female port openings 115 are respectively provided on the first side 123 and the second side 124. The first side 123 is a side closer to the first baffle plate 106 in the second direction, and the second side 124 is a side closer to the second baffle plate 107 in the second direction. That is to say, the front plate 121 is provided with the male port opening 114 and the female port opening 115; and the rear plate 122 is correspondingly provided with the male port opening 114 and the female port opening 115. The connection bar is provided with two male port poles 116 and two female port poles 117. The two male port poles 116 respectively protrude from the two male port openings 114, and the two female port poles 117 respectively protrude from the two female port openings 115.

By means of the arrangement of the two male port poles 116 and the female port poles 117, when there are a plurality of battery compartments 112, an electrical connection between the adjacent battery compartments 112 can also be realized in the second direction while the plurality of battery compartments 112 can be arranged in a stacking manner in the second direction. Exemplarily, when the plurality of battery compartments 112 are arranged in parallel, between the two adjacent battery compartments 112 which are arranged in a stacking manner in the second direction, the male port pole 116 of the first side 123 of one battery compartment 112 can be electrically connected to the male port pole 116 of the second side 124 of the other battery compartment 112, and the female port pole 117 of the first side 123 of one battery compartment 112 can be electrically connected to the female port pole 117 of the second side 124 of the other battery compartment 112, such that the plurality of battery compartments 112 can be arranged in parallel, so as to remain one male port pole 116 and one female port pole 117 at the positions closest to the electrical bin 101, to be respectively connected to the male port and the female port of the electrical bin 101 in an inserting manner, thereby facilitating the assembly and disassembly of the entire battery pack 100, and fully improving the efficiency of assembly and disassembly and maintenance.

In detail, further referring to FIG. 4 to FIG. 8, in this embodiment, the male port pole 116 and the female port pole 117, which protrude from the first side 123, are both provided with pole grooves 127, and external sizes of the female port pole 117 and the male port pole 116, which protrude from the second side 124, match internal sizes of the pole grooves 127. By means of such arrangement, the two adjacent battery compartments 112 which are arranged in a stacking manner in the second direction are able to be electrically connected in an inserting manner in the second direction. That is to say, in the two adjacent battery compartments 112, the male port pole 116 of first side 123 of one battery compartment 112 can be connected to the male port pole 116 of the second side 124 of the other battery compartment 112 in an inserting manner, so as to achieve an electrical connection; and the female port pole 117 of the first side 123 of one battery compartment 112 can also be connected to the female port pole 117 of the second side 124 of the other battery compartment 112 in an inserting manner, so as to achieve an electrical connection. By means of the arrangement of the pole grooves 127, on the one hand, positioning can be performed, so as to guarantee the stability and reliability of cooperation of the battery compartments 112; and on the other hand, the stability of the electrical connection between the adjacent battery compartments 112 is guaranteed, such that the safety of the battery pack 100 can be guaranteed. In addition, assembly and disassembly are completed by means of a plug-in connection of the poles, such that the efficiency of assembly and disassembly can be guaranteed, and the safety and reliability of assembly and disassembly operations can also be guaranteed.

Definitely, in other embodiments, insofar as the plurality of battery compartments 112 are arranged in parallel, one of the male port pole 116 and the female port pole 117, which are located on the first side 123, is provided with the pole groove 127, and the other one is not provided with the pole groove 127. In this case, the male port pole 116 of the second side 124 is not provided with the pole groove 127 correspondingly, so as to be connected, in an inserting manner, to the male port pole 116 provided with the pole groove 127; and at the same time, the female port pole 117 of the second side 124 is correspondingly provided with the pole groove 127, so as to be connected, in an inserting manner, to the female port pole 117 of the first side 123 that is not provided with the pole groove 127. This embodiment is not described again thereto.

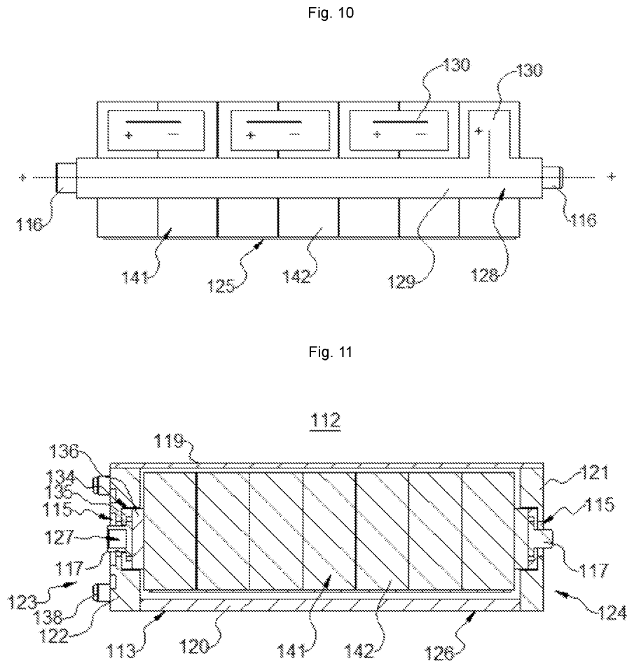

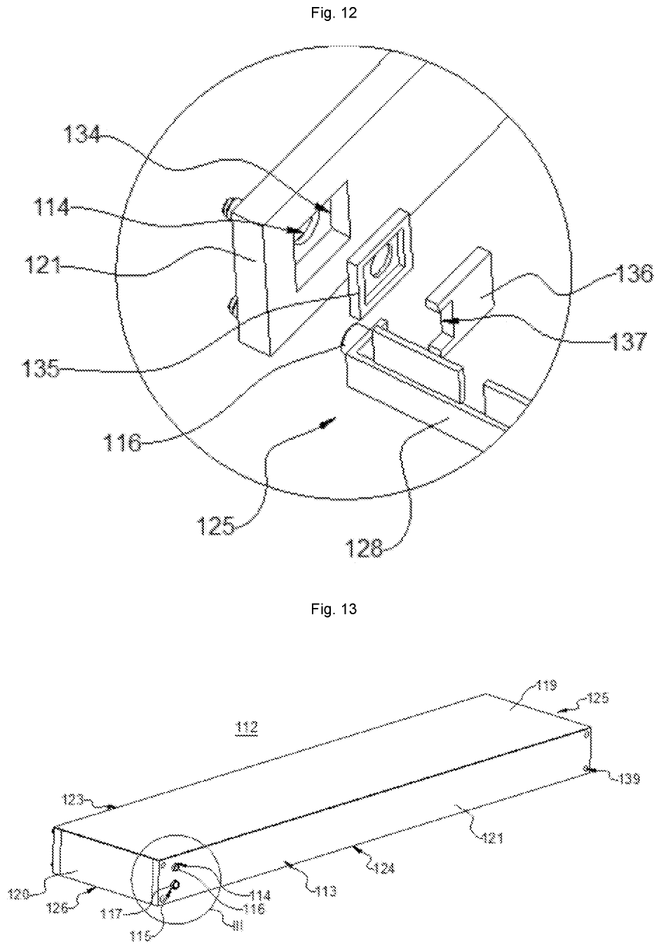

FIG. 9 is a schematic diagram I of a partial structure of a battery compartment 112 according to this embodiment. FIG. 10 is a schematic diagram II of a partial structure of a battery compartment 112 according to this embodiment. FIG. 11 is a schematic cross-sectional view of a battery compartment 112 according to this embodiment. FIG. 12 is a schematic diagram III of a partial structure of a battery compartment 112 according to this embodiment. Referring to FIG. 8 to FIG. 12, although in this embodiment, the plurality of battery compartments 112 are preferably arranged in parallel, to cause the remaining male port pole 116 and the female port pole 117 to be led out from the same side close to the electrical bin 101 after the plurality of battery compartments 112 are connected in parallel, so as to cooperate with the electrical bin 101, in this embodiment, the plurality of battery cells 142 of the battery cell assembly 141 of each battery compartment 112 is able to be selectively connected either in parallel or in series. For ease of wiring, in this embodiment, description is performed by using series connection as an example.

In detail, further referring to FIG. 8 to FIG. 10, in this embodiment, a positive pole and a negative pole of each battery cell of the plurality of battery cells 142 are respectively disposed on two end surfaces of the each battery cell 142, and the two end surfaces are respectively two end surfaces close to a third side 125 and a fourth side 126 of the battery shell 113. The third side 125 is a side closer to a first side beam 104 in the first direction, and the fourth side 126 is a side close to a second side beam 105 in the first direction. The plurality of battery cells 142 are arranged in a stacking manner in the second direction; and in the stacking direction, the positive pole of one battery cell of the plurality of battery cells 142 is disposed close to the negative pole of the other battery cell of the plurality of battery cells 142. After the plurality of battery cells 142 are arranged in a stacking manner, first-row pole and second-row pole are respectively formed at positions facing the third side 125 and the fourth side 126 of the battery shell 113. The first-row pole and the second-row pole include a plurality of positive poles and a plurality of negative poles which are successively alternately arranged in the stacking direction. As shown in FIG. 8 and FIG. 9, after seven battery cells 142 are arranged in a stacking manner in the second direction, in a direction from the front plate 121 to the rear plate 122, the first-row pole formed on the third side 125 are respectively the positive pole, the negative pole, the positive pole, the negative pole, the positive pole, the negative pole and the positive pole. Further as shown in FIG. 8 and FIG. 10, after the seven battery cells 142 are arranged in a stacking manner in the second direction, in the direction from the front plate 121 to the rear plate 122, the second-row pole formed on the fourth side 126 are respectively the negative pole, the positive pole, the negative pole, the positive pole, the negative pole, the positive pole and the negative pole.

Correspondingly, the connection bar includes a positive connection bar 128 and a negative connection bar 131. Referring to FIG. 10, the positive connection bar 128 and the negative connection bar 131 are both copper bars; and the positive connection bar 128 is disposed on the third side 125, and the negative connection bar is located on the fourth side 126. The positive connection bar 128 includes a positive main body 129 and a plurality of first bar plates 130. One of the plurality of first bar plates 130 is connected to the positive main body 129, and is connected to one positive pole in the first-row pole that is located at the end portion. Exemplarily, the first bar plate 130 disposed closest to the rear plate 122 is disposed on the positive main body 129, and is electrically connected to the positive pole of the battery cell 142 closest to the rear plate 122. The rest of the first bar plates of the plurality of first bar plates 130 are successively electrically connected to the rest positive poles and negative poles in the first-row pole. As shown in FIG. 10, for the three first bar plates 130 in the direction from the front plate 121 to the rear plate 122, each first bar plate 130 is connected to one positive pole and one negative pole.

Further referring to FIG. 9, the negative connection bar 131 includes a negative main body 132 and a plurality of second bar plates 133. One of the plurality of second bar plates 133 is connected to the negative main body 132, and is connected to one negative pole in the second-row pole that is located at the end portion. The rest of the second bar plates of the plurality of second bar plates 133 are successively electrically connected to the rest positive poles and negative poles in the second-row pole. Exemplarily, the second bar plate 133 in the plurality of second bar plates 133 that is closest to the front plate 121 is connected to the negative main body 132, and is connected to the negative pole of the battery cell 142 closest to the front plate 121. For the remaining three second bar plates 133, each second bar plate 133 is connected to one positive pole and one negative pole. By means of such arrangement, the seven battery cells 142 can be successively arranged in series by means of the positive connection bar 128 and the negative connection bar 131.

Correspondingly, the two male port poles 116 are respectively disposed on two ends of the positive main body 129 that are close to the first side 123 and the second side 124, that is, respectively disposed on positions close to the front plate 121 and the rear plate 122, so as to respectively protrude from the male port openings 114 of the first side 123 and the second side 124. The two female port poles 117 are respectively disposed on two ends of the negative main body 132 that are close to the first side 123 and the second side 124, so as to respectively protrude from the female port openings 115 of the first side 123 and the second side 124. By means of such arrangement, the battery compartment 112 can be in plug-in fit with the front and rear battery compartments 112, such that the efficiency and quality of assembly and disassembly can further improved.

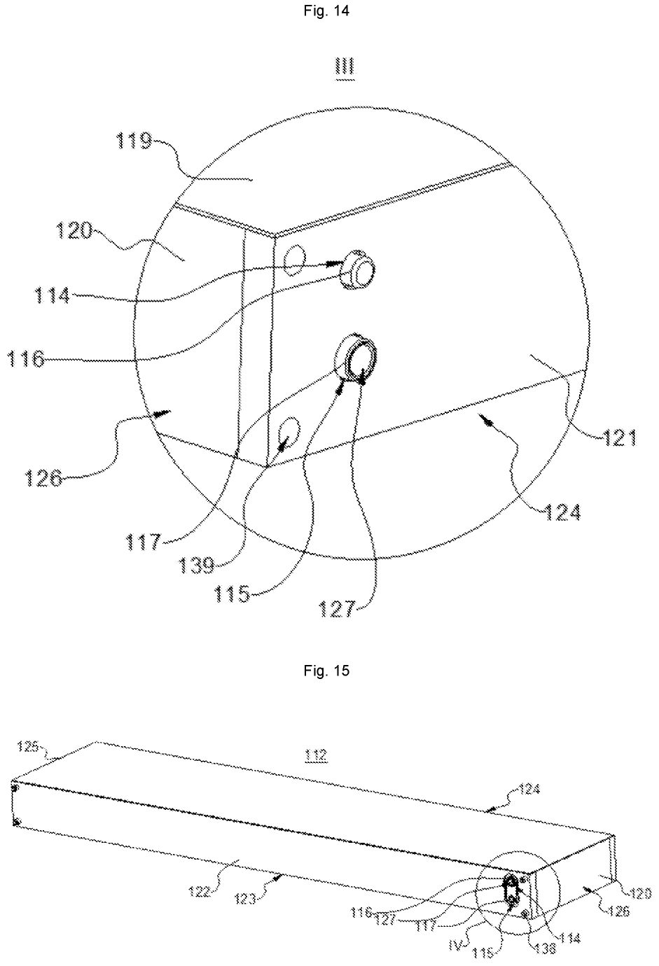

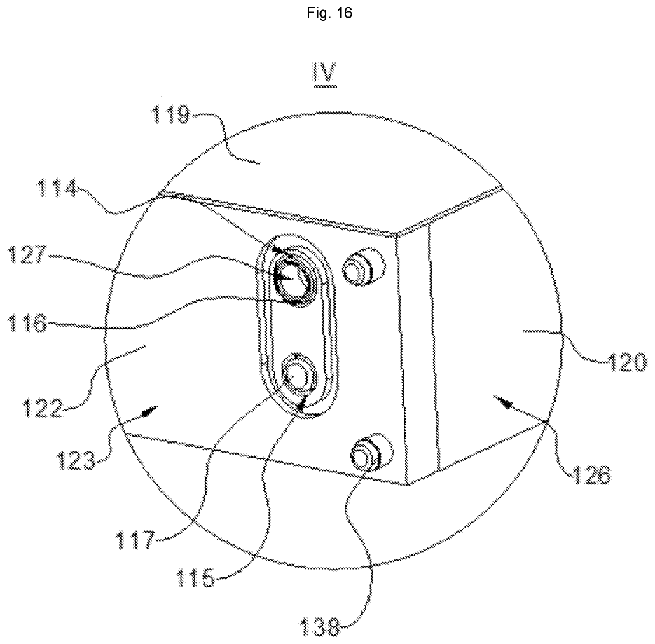

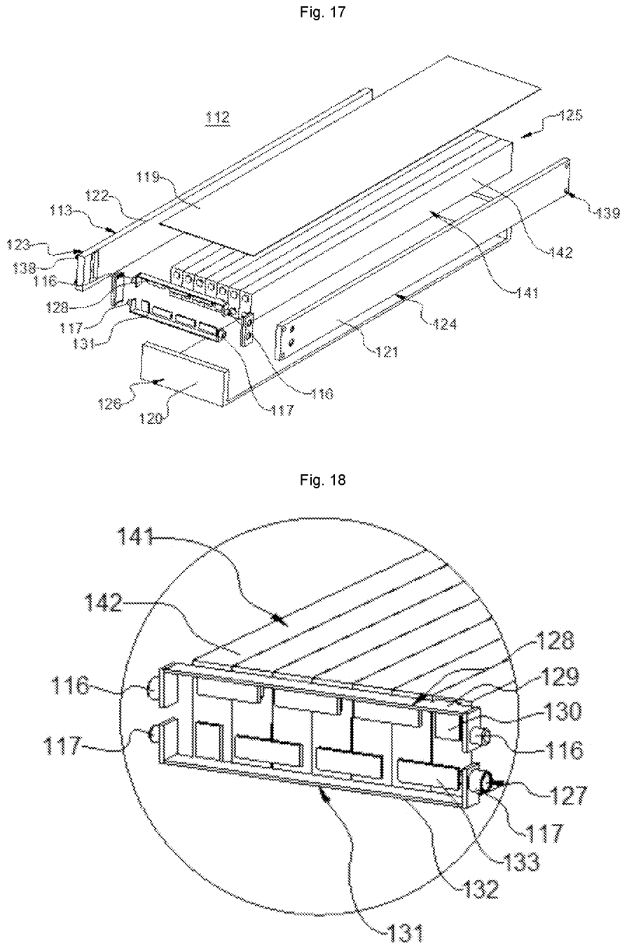

FIG. 13 is a schematic structural diagram I of another battery compartment 112 according to this embodiment. FIG. 14 is a partial enlarged view of a part III in FIG. 13. FIG. 15 is a schematic structural diagram II of another battery compartment 112 according to this embodiment. FIG. 16 is a partial enlarged view of a part IV in FIG. 15. FIG. 17 is a schematic exploded view of another battery compartment 112 according to this embodiment. Referring to FIG. 13 to FIG. 17, this embodiment further provides a battery compartment 112 of another structure. The difference between the battery compartment and the battery compartment 112 as shown in FIG. 4 to FIG. 12 lies in that, the positive poles and the negative poles of each battery cell of the plurality of battery cells 142 are disposed on the same end surface of the battery cell 142, exemplarily, being disposed at positions close to the same sides of the battery shell 113, for example, being disposed close to the fourth side 126 of the battery shell 113. The plurality of battery cells 142 are arranged in a stacking manner in the second direction; and after stacking, first-row pole and second-row pole, which are arranged side by side, are formed at positions facing the fourth side 126 of the battery shell 113. The first-row pole and the second-row pole include a plurality of positive poles and a plurality of negative poles which are successively alternately arranged in the stacking direction.

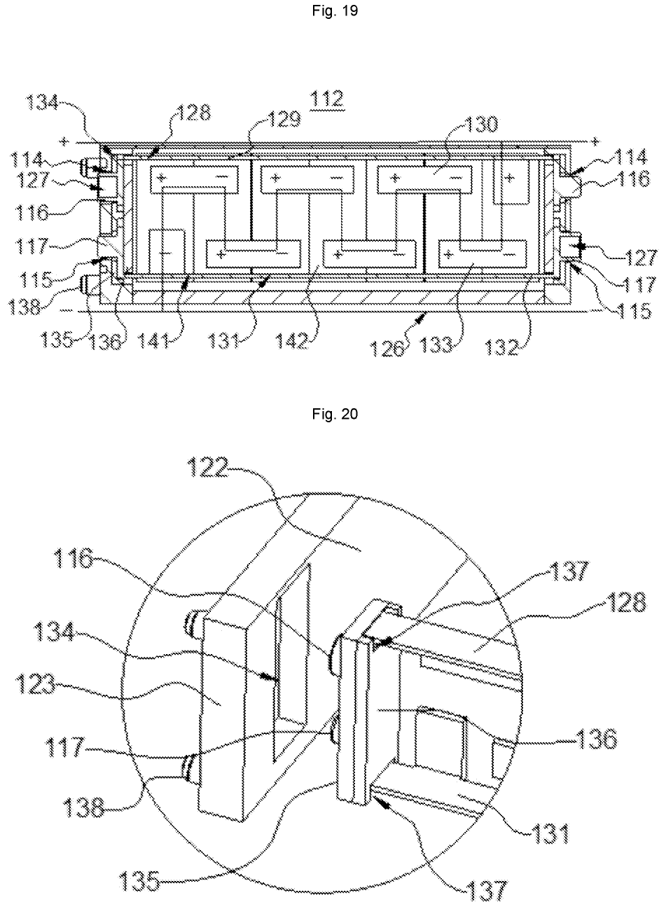

In detail, FIG. 18 is a schematic diagram I of a partial structure of another battery compartment 112 according to this embodiment. FIG. 19 is a schematic cross-sectional view of another battery compartment 112 according to this embodiment. Referring to FIG. 17 to FIG. 19, in this embodiment, on the basis of the positive poles and the negative poles leading out from the same sides of the battery cells 142, positions and structures of the positive connection bar 128 and the negative connection bar 131 of the connection bar also need to be correspondingly adjusted, so as to make the plurality of battery cells 142 still arranged in series.

In more detail, in this embodiment, each battery compartment 112 includes seven battery cells 142 which are arranged in a stacking manner in the second direction. Since the positive poles and the negative poles of the battery cells 142 lead out from the same side, for example, all leading out from the fourth side 126, the seven battery cells 142 can form the first-row pole and the second-row pole on the fourth side 126. The first-row pole includes seven poles, and in the direction from the front plate 121 to the rear plate 122, are successively the positive pole, the negative pole, the positive pole, the negative pole, the positive pole, the negative pole and the positive pole; and the second-row pole includes seven poles, and in the direction from the front plate 121 to the rear plate 122, are successively the negative pole, the positive pole, the negative pole, the positive pole, the negative pole, the positive pole and the negative pole.

Correspondingly, the positive connection bar 128 and the negative connection bar 131 are arranged at intervals at the position of the fourth side 126 in a vertical direction. The positive connection bar 128 is located above, and the negative connection bar 131 is located below. The positive connection bar 128 includes a positive main body 129 and a plurality of first bar plates 130. One of the plurality of first bar plates 130 is connected to the positive main body 129, and is connected to one positive pole in the first-row pole that is located at the end portion. The rest of the first bar plates of the plurality of first bar plates 130 are successively electrically connected to the rest positive poles and negative poles in the first-row pole. Exemplarily, the first bar plate 130 in the plurality of first bar plates 130 that is closest to the front plate 121 is connected to the positive main body 129, and is connected to the positive pole of the battery cell 142 closest to the front plate 121. For the remaining three first bar plates 130, each first bar plate 130 is connected to one positive pole and one negative pole. The negative connection bar 131 includes a negative main body 132 and a plurality of second bar plates 133. One of the plurality of second bar plates 133 is connected to the negative main body 132, and is connected to one negative pole in the second-row pole that is located at the end portion. The rest of the second bar plates of the plurality of second bar plates 133 are successively electrically connected to the rest positive poles and negative poles in the second-row pole. Exemplarily, the second bar plate 133 in the plurality of second bar plates 133 that is closest to the rear plate 122 is connected to the negative main body 132, and is connected to the negative pole of the battery cell 142 closest to the rear plate 122. For the remaining three second bar plates 133, each second bar plate 133 is connected to one positive pole and one negative pole. By means of such arrangement, the plurality of battery cells 142 can also be successively arranged in series.

Correspondingly, the two male port poles 116 are respectively disposed on two ends of the positive main body 129 that are close to the first side 123 and the second side 124, so as to respectively protrude from the male port openings 114 of the first side 123 and the second side 124. The two female port poles 117 are respectively disposed on two ends of the negative main body 132 that are close to the first side 123 and the second side 124, so as to respectively protrude from the female port openings 115 of the first side 123 and the second side 124. In addition, in order to achieve the plug-in connection between the adjacent battery compartments 112, the male port pole 116 protruding from the first side 123 is provided with the pole groove 127, and the female port pole 117 protruding from the first side 123 is not provided with the pole groove 127; the male port pole 116 protruding from the second side 124 is not provided with the pole groove 127, and the female port pole 117 protruding from the second side 124 is provided with the pole groove 127; and the external sizes of the male port pole 116 and the female port pole 117, which are not provided with the pole groove 127, match the internal size of the pole groove 127.

By means of such arrangement, when the two adjacent battery compartments 112 are electrically connected, the pole groove 127 of the male port pole 116 of the first side 123 of one battery compartment 112 is able to be plugged with the male port pole 116 of the second side 124 of the other battery compartment 112. The female port pole 117 on the first side 123 of one battery compartment 112 is able to be connected, in an inserting manner, to the pole groove 127 of the female port pole 117 on the second side 124 of the other battery compartment 112. Therefore, the parallel connection between the battery compartments 112 can be achieved, and the efficiency and quality of assembly and disassembly and maintenance among the plurality of battery compartments 112 can also be guaranteed.

Definitely, in other embodiments, one of the two male port poles 116 protruding from the first side 123 and the second side 124 may also be provided with the pole groove 127; and one of the two female port poles 117 protruding from the first side 123 and the second side 124 is able to be provided with the pole groove 127. One of the male port pole 116 and the female port pole 117, which are provided with the pole grooves 127, is located on the first side 123, and the other is located on the second side 124. The external sizes of the male port pole 116 and the female port pole 117, which are not provided with the pole groove 127, match the internal size of the pole groove 127, such that a requirement of the parallel connection between the battery compartments 112 can be met, so as to remain one male port pole 116 and one female port pole 117 on the same sides close to the electrical bin 101. This embodiment is not limited thereto.

It is to be noted that, in this embodiment, when there is one battery compartment 112, the battery compartment 112 may also be provided with one male port pole 116 and one female port pole 117 only, so as to be able to be directly plugged in the male port and the female port of the electrical bin 101. When there are a plurality of battery compartments 112, for ease of mold opening and manufacturing, to reduce manufacturing cost, each battery compartment 112 is able to be designed as a structure which is provided with two male port poles 116 and two female port poles 117. By means of such arrangement, after the plurality of battery compartments 112 and the electrical bin 101 are plugged in order, and there are one male port pole 116 and one female port pole 117 still remained in the battery compartment 112 closest to the second baffle plate 107. In this case, an insulation sealing gasket is able to be disposed between the battery compartment 112 located at a far end portion (that is, the battery compartment 112 closest to the rear plate 122) and the second baffle plate 107. The remaining male port pole 116 and female port pole 117 can be inserted into the insulation sealing gasket. The insulation sealing gasket can protect the poles while sealing the poles, so as to improve the safety of the battery pack 100. Definitely, the insulation sealing gasket may also be disposed between another position of the battery compartment 112 and a corresponding position of the frame 103, as long as the assembly and disassembly of the battery compartment 112 and the electrical bin 101 are not affected. In addition, the insulation sealing gasket may also be replaced with a sealing groove 140 or even a sealing hole, as long as the remaining male port pole 116 and female port pole 117 can be protected. This embodiment is not limited thereto.

It is further to be noted that, in this embodiment, in the stacking direction of the plurality of battery compartments 112, in the two adjacent battery compartments 112, the male port pole 116 on the first side 123 of one battery compartment 112 is plugged in the female port pole 117 on the second side 124 of the other battery compartment 112, so as to achieve the series connection of the plurality of battery compartments 112. This embodiment is not described again thereto.

Further referring to FIG. 11, FIG. 12, FIG. 19 and FIG. 20, regardless of the positive poles and the negative poles of the battery cell 142 being led out from the same side of the battery cell 142 or two sides of the battery cell 142, in this embodiment, the sides of the battery shell 113 that are close to the battery cell 142 at the male port opening 114 and the female port opening 115 is able to be provided with embedded grooves 134 according to requirements. The embedded grooves 134 can communicate with the corresponding male port opening 114 or the corresponding female port opening 115. As shown in FIG. 11 and FIG. 12, since the male port opening 114 and the female port opening 115 are located far apart, there are the embedded grooves 134 respectively provided at the male port opening 114 and the female port opening 115. As shown in FIG. 19 and FIG. 20, since the male port opening 114 and the female port opening 115 are provided adjacent to each other, the male port opening 114 and the female port opening 115 may share one embedded groove 134.

At the same time, the battery compartment 112 further includes a plurality of first insulating pads 135 corresponding to the number of the embedded grooves 134. Each first insulating pad 135 is provided with a hole which is coaxial with the corresponding male port opening 114 or the female port opening 115, and at least part of each first insulating pad 135 can be accommodated in the embedded groove 134. The first insulating pad 135 at the male port opening 114 is disposed outside the corresponding male port pole 116 in a sleeving manner, and abuts against a wall surface of the connection bar that is provided with the male port pole 116. The first insulating pad 135 at the female port opening 115 is disposed outside the corresponding female port pole 117 in a sleeving manner, and abuts against a wall surface of the connection bar that is provided with the female port pole 117. By means of the arrangement of the first insulating pad 135, insulation and dust prevention effects can be provided to the female port pole 117 or the male port pole 116, so as to improve the safety and stability of the battery compartment 112, thereby further improving the safety and stability of the battery pack 100.

As an optional scheme, further referring to FIG. 11, FIG. 12, FIG. 19 and FIG. 20, the battery compartment 112 further includes a plurality of second insulating pads 136 corresponding to the number of the embedded grooves 134. The first insulating pads 135 are all accommodated in the corresponding embedded grooves 134. The second insulating pads 136 are at least partially accommodated in the embedded groove 134. The first insulating pad 135 and the second insulating pad 136 at the male port opening 114 are respectively abut against two sides of the wall surface of the connection bar that is provided with the male port pole 116. The first insulating pad 135 and the second insulating pad 136 at the female port opening 115 are respectively abut against two sides of the wall surface of the connection bar that is provided with the female port pole 117. By means of the arrangement of the second insulating pad 136, insulation and dust prevention effects can be provided to the female port pole 117 or the male port pole 116, so as to improve the safety and stability of the battery compartment 112, thereby further improving the safety and stability of the battery pack 100.

At the same time, by means of the cooperation of the first insulating pad 135 and the second insulating pad 136, the stability of the male port pole 116 and the female port pole 117 can be fully guaranteed, such that the strength of the connection bar can be guaranteed, thereby further improving the safety, stability and reliability of the battery compartment 112 and the battery pack 100.

As an optional scheme, further referring to FIG. 12 and FIG. 20, in this embodiment, the second insulating pad 136 is provided with an inserting groove 137, and the connection bar is plugged in the inserting groove 137. As shown in FIG. 12, the second insulating pad 136 is approximately of a “C”-shaped structure, and the inner side of the “C”-shaped structure forms the inserting groove 137, so as to be connected to the positive main body 129 or the negative main body 132 in an inserting manner, such that the safety and stability of the second insulating pad 136 are guaranteed, thereby further improving the safety, stability and reliability of the battery compartment 112 and the battery pack 100. As further shown in FIG. 20, since the positive connection bar 128 and the negative connection bar 131 are arranged at intervals in the vertical direction, the second insulating pad 136 is able to be designed as a long-strip structure, of which upper end is provided with a “C”-shaped inserting groove 137, and lower end is also provided with a “C”-shaped inserting groove 137, so as to be respectively connected to the positive main body 129 and the negative main body 132 in an inserting manner, such that the safety and stability of the second insulating pad 136 are fully improved, thereby further improving the safety, stability and reliability of the battery compartment 112 and the battery pack 100.

Further referring to FIG. 4 to FIG. 8 and FIG. 13 to FIG. 17, regardless of the positive poles and the negative poles of the battery cell 142 being led out from the same side of the battery cell 142 or two sides of the battery cell 142, in this embodiment, the battery shell 113 of the battery compartment 112 may further be provided with an inserting hole 139 and an inserting column 138. The electrical bin 101 may also be provided with the inserting hole 139 and the inserting column 138 accordingly, such that when the battery compartment 112 is connected to the battery compartment 112 in an inserting manner, and the battery compartment 112 is connected to the electrical bin 101 in an inserting manner, positioning can be performed by means of the inserting hole 139 and the inserting column 138; and by means of the inserting connection and cooperation of the inserting hole 139 and the inserting column 138, the efficiency and quality of assembly and disassembly of the battery pack 100 are further improved, so as to further improve the stability and safety of the battery pack 100.

In detail, in this embodiment, the rear plate 122 of the battery shell 113 of the battery compartment 112 is provided with the inserting column 138, and the front plate 121 is provided with the inserting hole 139. There are four inserting columns 138 and four inserting holes 139, each of which is located at each of the four corners of the front plate 121 and the rear plate 122, which is disposed in a rectangular array. When the two adjacent battery compartments 112, the four inserting holes 139 can be connected to the four inserting columns 138 in an inserting manner, so as to guarantee the stability of the battery compartments 112, thereby improving the efficiency and quality of assembly and disassembly of the battery compartments 112. Definitely, in other embodiments, any one of the first side 123 and the second side 124 may also be provided with the inserting hole 139, that is, any one of the front plate 121 and the rear plate 122 is provided with the inserting hole 139; and the other one of the first side 123 and the second side 124 is provided with the inserting column 138, that is, any one of the front plate 121 and the rear plate 122 is provided with the inserting column 138, so as to make the external size of the inserting column 138 match the internal size of the inserting hole 139, thereby achieving inserting connection and cooperation. This embodiment is not limited thereto.

At the same time, since the position close to the electrical bin 101 is the first side 123 of the battery compartment 112, and the rear plate 122 on the first side 123 of the battery compartment 112 is provided with the inserting column 138, a bin wall of the electrical bin 101 is able to be correspondingly provided with the inserting hole 139, such that the battery compartment 112 can be connected, in an inserting manner, to and cooperate with the electrical bin 101 and perform positioning, so as to further improving the safety, stability and reliability of the battery pack 100. Definitely, in other embodiments, when the side of the battery compartment 112 that is provided with the inserting hole 139 is adjacent to the electrical bin 101, the bin wall of the electrical bin 101 may also be provided with the inserting column 138 according to requirements. This embodiment is not described again thereto.

In addition, by means of the above arrangement, the position closest to the second baffle plate 107 is the front plate 121 of the battery compartment 112; the front plate 121 is provided with the inserting hole 139; and the electrical bin 101 closest to the first baffle plate 106 is also provided with the inserting hole 139. Therefore, further referring to FIG. 2, in order to further improve the stability of the battery pack 100, in this embodiment, the first baffle plate 106 may also be provided with a first mounting hole 110, and is firmly connected to the electrical bin 101 by means of pins; and the second baffle plate 107 may also be provided with a second mounting hole 111, and is firmly connected to the battery compartment 112 on the far-end edge by means of the pins, so as to improve the stability of the entire battery pack 100 in a plurality of direction, thereby further guaranteeing the stability, reliability and safety of the battery compartment 112 and the battery pack 100.

Further referring to FIG. 7, in this embodiment, at least one of the first side 123 or the second side 124 of the battery compartment 112 is provided with a sealing groove 140, that is, at least one of the front plate 121 or the rear plate 122 is provided with the sealing groove 140. Exemplarily, the rear plate 122 is able to be provided with the sealing groove 140, and the sealing groove 140 is in a ring shape. The battery compartment 112 further includes a sealing ring which can be at least partially accommodated in the sealing groove 140. By means of the arrangement of the sealing ring, a sealing connection between the adjacent battery compartments 112 can be achieved, and a sealing connection between the battery compartment 112 and the electrical bin 101 can also be achieved, so as to fully guarantee the stability and safety of the battery pack 100.

It is to be noted that, in this embodiment, the sealing ring, the insulation sealing gasket, the first insulating pad 135 and the second insulating pad 136 are all make of a sealing insulation material, for example, materials such as insulating rubber, which can provide sealing and insulation functions. In this embodiment, the type of the material is not limited.

It is to be further noted that, in this embodiment, the number of the battery compartments 112, the number of the battery cells 142 in the battery cell assembly 141 in each battery compartment 112, an electrical connection mode of the battery cells 142, and an electrical connection mode of the battery compartments 112 may all be adjusted according to requirements, such that battery packs 100 with different performance and electric quantities can be matched according to different electric quantity requirements, so as to better adapt different electric quantity requirements of electric devices such as an electric automobile. This embodiment is not limited thereto.

An embodiment of the disclosure further provides an electric device. The electric device includes an electric mechanism, and the battery compartment 112 or the battery pack 100 described above. The electric mechanism may select mechanisms such as vehicles, ships and spacecrafts. The electric mechanism is able to be powered by means of the battery compartment 112 or the battery pack 100 described above. Therefore, the electric device also has the advantage of being low in cost.

A mounting process, a working principle and beneficial effects of the battery pack 100 provided in the embodiments of the disclosure are introduced in detail below by using the structure of the battery compartment 112 shown in FIG. 4 to FIG. 8 as an example.

When the battery pack 100 is mounted, the first side beam 104, the second side beam 105 and the first baffle plate 106 may first be assembled; then the electrical bin 101 is slid to the first baffle plate 106 along the sliding grooves 108 of the first side beam 104 and the second side beam 105, and the inserting hole 139 in the electrical bin 101 and the first mounting hole 110 of the first baffle plate 106 are placed opposite to each other and are firmly connected by means of the pins; then the plurality of battery compartments 112 are slid into the sliding grooves 108, when the battery compartment 112 cooperates with the electrical bin 101, the inserting column 138 on the first side 123 of the battery compartments 112 is inserted into the inserting hole 139 of the electrical bin 101, and the inserting column 138 on the first side 123 of the subsequent battery compartment 112 is inserted into the inserting hole 139 on the second side 124 of the previous battery compartment 112; at the same time, the male port pole 116 on the first side 123 of the battery compartment 112 close to the electrical bin 101 is connected to the male port of the electrical bin 101 in an inserting manner, and the female port pole 117 is connected to the female port in an inserting manner; between the subsequent battery compartments 112, the male port pole 116 on the second side 124 of the previous battery compartment 112 is inserted into the pole groove 127 of the male port pole 116 on the first side 123 of the next battery compartment 112, and the female port pole 117 on the second side 124 of the previous battery compartment 112 is inserted in the pole groove 127 of the female port pole 117 on the first side 123 of the next battery compartment 112; and finally, the second baffle plate 107 cooperates with the first side beam 104 and the second side beam 105, and the inserting hole 139 of the battery compartment 112 closest to the second baffle plate 107 and the second mounting hole 111 in the second baffle plate 107 are placed opposite to each other and are firmly connected by means of the pins. The battery pack 100 is able to be connected to an external electric mechanism by means of the electrical bin 101 after mounting, so as to perform charging and discharging operations.

In the above process, on the one hand, the battery cell assembly 141 of the battery compartment 112 directly protrudes from an opening by means of the male port pole 116 and the female port pole 117, such that an electrical connection, in an inserting manner, with other battery compartments 112 or the electrical bin 101 can be realized, thereby achieving stable charging and discharging; and the battery compartment is simple in structure, and the connection bar does not need to be externally disposed, such that the size of the connection bar can be decreased, and production costs can be reduced. On the other hand, the battery compartment 112 and the electrical bin 101 are of modular structures, and is assembled and disassembled by mating with and separating the male port pole 116 and the female port pole 117 from structures which are respectively adjacent to the male port pole and the female port pole, such that maintenance efficiency can be improved, and maintenance costs can be reduced.

To sum up, the embodiments of the disclosure provide a battery compartment 112 with a simple structure and convenient assembling and disassembling, so as to improve maintenance efficiency and reduce maintenance cost. In addition, the battery compartment 112 is connected to an electrical structure or other battery compartments 112 by means of a male port pole 116 and a female port pole 117, such that a connection bar does not need to be externally disposed, and the size of the connection bar is decreased, and therefore, production costs can be reduced. An embodiment of the disclosure further provides a battery pack 100. The battery pack includes the battery compartment 112. Therefore, the battery pack 100 also has the advantages of being simple in structure, convenient in assembling and disassembling, high in maintenance efficiency and low in production cost. An embodiment of the disclosure further provides an electric device. The electric device is powered by means of the battery compartment 112 or the battery pack 100. Therefore, the electric device also has the advantage of being low in cost.

The above is only the specific implementations of the disclosure and not intended to limit the scope of protection of the disclosure. Any variations or replacements apparent to those skilled in the art within the technical scope disclosed by the disclosure shall fall within the scope of protection of the disclosure. Therefore, the scope of protection of the disclosure shall be subject to the scope of protection of the claims.

What is claimed is:

1. A battery compartment, comprising:
a battery shell, provided with a male port opening and a female port opening; and
a battery cell assembly, disposed in the battery shell, and comprising a connection bar and a plurality of battery cells, wherein the connection bar is configured to electrically connect the plurality of battery cells and is provided with a male port pole and a female port pole, the male port pole protrudes from the male port opening, and the female port pole protrudes from the female port opening.

2. The battery compartment according to claim 1, wherein
the battery shell is provided with two male port openings and two female port openings, wherein the two male port openings are respectively provided on a first side and a second side of the battery shell that are opposite to each other, and the two female port openings are respectively provided on the first side and the second side; and
the connection bar is provided with two male port poles and two female port poles, wherein the two male port poles respectively protrude from the two male port openings, and the two female port poles respectively protrude from the two female port openings.

3. The battery compartment according to claim 2, wherein
the male port pole and the female port pole, which protrude from the first side, are both provided with pole grooves, and external sizes of the female port pole and the male port pole, which protrude from the second side, match internal sizes of the pole grooves;
or,
one of the two male port poles protruding from the first side and the second side is provided with the pole groove; one of the two female port poles protruding from the first side and the second side is provided with the pole groove; one of the male port pole and the female port pole that is provided with the pole groove is located on the first side, and the other is located on the second side; and the external sizes of the male port pole and the female port pole which are not provided with the pole grooves match the internal sizes of the pole grooves.

4. The battery compartment according to claim 2, wherein
the plurality of battery cells are arranged in series or parallel by means of the connection bar.

5. The battery compartment according to claim 2, wherein
a positive pole and a negative pole of each battery cell of the plurality of battery cells are respectively disposed on two end surfaces of the each battery cell; the plurality of battery cells are arranged in a stacking manner; in a stacking direction, the positive pole of one battery cell of the plurality of battery cells is arranged close to the negative pole of the other battery cell of the plurality of battery cells; after the plurality of battery cells are arranged in a stacking manner, a first-row pole and a second-row pole are respectively formed at positions facing a third side and a fourth side of the battery shell; the first-row pole and the second-row pole comprise a plurality of positive poles and a plurality of negative poles which are successively alternately arranged in the stacking direction;
the connection bar comprises a positive connection bar and a negative connection bar; the positive connection bar comprises a positive main body and a plurality of first bar plates; one of the plurality of first bar plates is connected to the positive main body, and is connected to one positive pole in the first-row pole that is located at an end portion; the rest of the first bar plates of the plurality of first bar plates are successively electrically connected to the rest of the plurality of positive poles and the plurality of negative poles in the first-row pole; the negative connection bar comprises a negative main body and a plurality of second bar plates; one of the plurality of second bar plates is connected to the negative main body and is connected to one negative pole in the second-row pole that is located at an end portion; the rest of the second bar plates of the plurality of second bar plates are successively electrically connected to the rest of the plurality of positive poles and the plurality of negative poles in the second-row pole, so as to make the plurality of battery cells successively arranged in series;
the two male port poles are respectively disposed on two ends of the positive main body that are close to the first side and the second side, so as to respectively protrude from the male port openings of the first side and the second side; and the two female port poles are respectively disposed on two ends of the negative main body that are close to the first side and the second side, so as to respectively protrude from the female port openings of the first side and the second side.

6. The battery compartment according to claim 2, wherein
a positive pole and a negative pole of each battery cell of the plurality of battery cells are disposed on the same end surface of the battery cell; the plurality of battery cells are arranged in a stacking manner, and after stacking, a first-row pole and a second-row pole, which are arranged side by side, are formed at positions facing the same side of the battery shell; the first-row pole and the second-row pole comprise a plurality of positive poles and a plurality of negative poles which are successively alternately arranged in a stacking direction;
the connection bar comprises a positive connection bar and a negative connection bar; the positive connection bar comprises a positive main body and a plurality of first bar plates; one of the plurality of first bar plates is connected to the positive main body, and is connected to one positive pole in the first-row pole that is located at an end portion; the rest of the first bar plates of the plurality of first bar plates are successively electrically connected to the rest of the plurality of positive poles and the plurality of negative poles in the first-row pole; the negative connection bar comprises a negative main body and a plurality of second bar plates; one of the plurality of second bar plates is connected to the negative main body and is connected to one negative pole in the second-row pole that is located at an end portion; the rest of the second bar plates of the plurality of second bar plates are successively electrically connected to the rest of the plurality of positive poles and the plurality of negative poles in the second-row pole, so as to make the plurality of battery cells successively arranged in series;
the two male port poles are respectively disposed on two ends of the positive main body that are close to the first side and the second side, so as to respectively protrude from the male port openings of the first side and the second side; and the two female port poles are respectively disposed on two ends of the negative main body that are close to the first side and the second side, so as to respectively protrude from the female port openings of the first side and the second side.

7. The battery compartment according to claim 1, wherein
the battery shell is provided with embedded grooves in the sides of the male port opening and the female port opening that are close to the battery cells, and the embedded grooves are capable of communicating with the corresponding male port opening or the corresponding female port opening; and
the battery compartment further comprises a plurality of first insulating pads corresponding to the number of the embedded grooves, wherein each first insulating pad is provided with a hole which is coaxial with the corresponding male port opening or the female port opening, and at least part of each first insulating pad is capable of being accommodated in the embedded groove; the first insulating pad at the male port opening is disposed outside the corresponding male port pole in a sleeving manner, and abuts against a wall surface of the connection bar that is provided with the male port pole; and the first insulating pad at the female port opening is disposed outside the corresponding female port pole in a sleeving manner, and abuts against a wall surface of the connection bar that is provided with the female port pole.

8. The battery compartment according to claim 7, further comprising
a plurality of second insulating pads corresponding to the number of the embedded grooves, wherein the first insulating pads are all accommodated in the corresponding embedded grooves; the second insulating pads are at least partially accommodated in the embedded groove; the first insulating pad and the second insulating pad at the male port opening are respectively abut against two sides of the wall surface of the connection bar that is provided with the male port pole; and the first insulating pad and the second insulating pad at the female port opening are respectively abut against two sides of the wall surface of the connection bar that is provided with the female port pole.

9. The battery compartment according to claim 8, wherein
the second insulating pads are provided with inserting grooves, and the inserting grooves are connected to the connection bar in an inserting manner.

10. The battery compartment according to claim 1, wherein the battery shell has a first side and a second side, which are opposite to each other;
one of the first side and the second side is provided with an inserting hole, and the other one of the first side and the second side is provided with an inserting column; and an external size of the inserting column matches an internal size of the inserting hole; and/or
at least one of the first side or the second side is provided with a sealing groove; and the battery compartment further comprises a sealing ring which is capable of being at least partially accommodated in the sealing groove.

11. A battery pack, comprising the battery compartment according to claim 1.

12. The battery pack according to claim 11, further comprising
an electrical bin, wherein the electrical bin is provided with a male port and a female port; and the male port pole of the battery compartment is inserted in the male port, and the female port pole is inserted in the female port.

13. The battery pack according to claim 11, comprising
a plurality of battery compartments which are arranged in a stacking manner, wherein each battery compartment is provided with two male port poles and two female port poles; the two male port poles are respectively disposed on a first side and a second side of a battery shell that are opposite to each other, and the two female port poles are respectively disposed on the first side and the second side;
in a stacking direction of the plurality of battery compartments, in two adjacent battery compartments, the male port pole and the female port pole of the first side of one battery compartment are connected to the male port pole and the female port pole of the second side of the other battery compartment in an inserting manner, so as to achieve a parallel connection of the plurality of battery compartments; or in the stacking direction of the plurality of battery compartments, in the two adjacent battery compartments, the male port pole of the first side of one battery compartment is connected to the female port pole of the second side of the other battery compartment in an inserting manner, so as to achieve a series connection of the plurality of battery compartments.

14. The battery pack according to claim 13, wherein
the plurality of battery compartments are arranged in parallel; after the plurality of battery compartments are connected in parallel, the remaining male port pole and female port pole are located on the same sides of the battery compartments; and
the battery pack further comprises an electrical bin, wherein the electrical bin is provided with a male port and a female port; and the remaining male port pole is inserted in the male port, and the remaining female port pole is inserted in the female port.

15. The battery pack according to claim 12, wherein
the battery shell has a first side and a second side, which are opposite to each other; the first side is provided with an inserting column, the second side is provided with an inserting hole, and an external size of the inserting column matches an internal size of the inserting hole;
when the first side of the battery compartment matching the electrical bin is arranged close to the electrical bin, a bin wall of the electrical bin is provided with the inserting hole, and the inserting hole is connected to the inserting column at a corresponding position; and when the second side of the battery compartment matching the electrical bin is arranged close to the electrical bin, the bin wall of the electrical bin is provided with the inserting column, and the inserting column is connected to the inserting hole at a corresponding position.

16. The battery pack according to claim 11, further comprising
a frame, wherein the battery pack comprises a plurality of battery compartments which are arranged in the frame in a stacking manner, and in a stacking direction of the plurality of battery compartments, the battery compartment located at a far end portion is firmly connected to the frame;
or,
a frame and an electrical bin, wherein the battery pack comprises a plurality of battery compartments, the electrical bin and the plurality of battery compartments are successively arranged in the frame in a stacking manner, the electrical bin is firmly connected to the frame, and the battery compartment in the plurality of battery compartments that is away from the electrical bin is firmly connected to the frame.

17. The battery pack according to claim 11, further comprising
a frame, wherein the frame is provided with a sliding groove, and the battery compartment is connected to the sliding groove in an inserting manner.

18. The battery pack according to claim 17, wherein
the frame comprises a first side beam and a second side beam which are opposite to and spaced apart from each other, and a first baffle plate and a second baffle plate which are opposite to each other and arranged between the first side beam and the second side beam in a spaced manner, and the first side beam, the second side beam, the first baffle plate and the second baffle plate jointly form a square frame body;
the first side beam and the second side beam are respectively provided with the sliding grooves; and two ends of the battery compartment are respectively connected to the two sliding grooves in an inserting manner, and slide in an extending direction of the sliding grooves;
at least one groove wall of the sliding groove is provided with a roller, and the battery compartment is in sliding fit with the roller.

19. The battery pack according to claim 11, comprising
a plurality of battery compartments, and further comprising a frame, wherein the plurality of battery compartments are arranged in the frame in a stacking manner; and in a stacking direction of the plurality of battery compartments, an insulation sealing gasket is disposed between the battery compartment located at a far end portion and a corresponding position of the frame.

20. An electric device, comprising:
an electric mechanism; and
the battery compartment according to claim 1, wherein the battery compartment is configured to supply power for the electric mechanism; or the battery pack according to claim 11, wherein the battery pack is configured to supply power for the electric mechanism.
